(19) United States
(12) Patent Application Publication
(10) Pub. No.: US 2022/0411058 A1
(43) Pub. Date: Dec. 29, 2022

(54) Penetrating High Wing Structure of Civil Aircraft with Blended-Wing-Body

(71) Applicants: Yongjie Zhang, Xian (CN); Jingpiao Zhou, Xian (CN); Lei Shi, Xian (CN); Dong Li, Xian (CN); Binqian Zhang, Xian (CN)

(72) Inventors: Yongjie Zhang, Xian (CN); Jingpiao Zhou, Xian (CN); Lei Shi, Xian (CN); Dong Li, Xian (CN); Binqian Zhang, Xian (CN)

(21) Appl. No.: 17/385,945

(22) Filed: Jul. 27, 2021

(30) Foreign Application Priority Data
Jun. 25, 2021 (CN) 202110712076.7

(51) Int. Cl. B64C 39/10; B64C 3/18; B64D 11/00; B64D 9/00; B64C 1/14; B64D 27/02; B64C 5/06; B64C 3/10

(52) U.S. Cl. CPC B64C 39/10; B64C 3/185; B64C 3/187; B64D 11/00; B64D 9/00; B64C 1/1423; B64D 27/02; B64C 5/06; B64C 3/10; B64C 2039/105

(57) ABSTRACT

The disclosure provides a penetrating high wing structure of civil aircraft with blended-wing-body, wherein the structure comprises a left wing, a right wing and a high wing penetrating central wing. The left wing and the right wing are symmetrically arranged and connected to two sides of the high wing penetrating central wing through fasteners respectively, and the high wing penetrating central wing is arranged on the top of the main body. The left wing and the right wing both comprise wing ribs and wing spars that are arranged in a crisscross way. The disclosure proposes a penetrating high wing structure, wherein the wing and the body are designed as a whole so that the wings will not damage the continuity of the internal space of the body, which improves the load transfer efficiency of the structure and reduces the fasteners used for connection, thus reducing the weight of the body.

### TECHNICAL FIELD

The disclosure relates to the technical field of aviation aircraft design, specifically relating to a penetrating high wing structure of civil aircraft with blended-wing-body.

### BACKGROUND

In recent years, with the rapid development of China's economy and the continuous improvement of people's living standards, the civil aviation industry has made great progress. As of the end of 2019, the civil aviation passenger transportation volume has reached 659,934,200 person-times, with an increase of 7.9% over 2018, and has continued to maintain the high-speed development level in recent years. Based on the forecasts provided by IATA, the Asia-Pacific region will be the largest driver to promote the growth of global aviation demand, and China will replace the United States as the world's largest aviation market in the future. Therefore, the construction of large international airports, the improvement of service level and the increasing flight demand of the people indicate the broad development prospects of China's civil aviation industry. However, the number of take-offs and landings at large airports is limited, so it is necessary to increase the passenger capacity of aircraft. This puts forward higher requirements for the structural weight and carrying efficiency of civil aircraft in China.

The commonly used body section shapes include circular, oval, square, trapezoid, etc. These shapes are suitable for aircraft with different purposes and speed ranges. For example, low-speed aircraft can be square, while high-subsonic large passenger aircraft with pressure cabins can be mostly circular or oval. The jet fighter is generally of irregular shape, and the existing civil aircraft body structure is mostly circular. The civil aircraft with a traditional circular section body has circular body and obvious wings and tail fins. For civil aircraft with a traditional circular section body, the circular body is the main body that carries the load, and the wings are the main body that generates the lifting force. The circular body only produces little or no lifting force, and the wings only carry little or no load, resulting in low carrying efficiency. The stress is concentrated at the wing root where the wings are combined with the circular body, so it is necessary to greatly strengthen the local structure to increase the weight. For many years, research has been devoted to aerodynamic aircraft with lighter structure weight and higher carrying efficiency.

Compared with the traditional circular body, the civil aircraft with blended-wing-body has the characteristics of high lift-drag ratio, low noise, low fuel consumption, light structural weight and high carrying efficiency, and is one of the most potential development types of aircraft layout in the future. For civil aircraft with blended-wing-body, the middle wing configuration and the connection mode of the left wing-body-central wing box-body-right wing are often used. However, the multi-cabin structure of civil aircraft with blended-wing-body based on the middle wing configuration has potential risks such as overweight structure and low carrying efficiency, which will lead to aerodynamic design problems. For example, the disadvantage of the cylindrical combined multi-cabin structure is that the multi-cylinder structure brings great challenges to the continuity of the body force transmission path, the connection characteristics of complex curved surfaces, the tightness of the cabin and the feasibility of processing and manufacturing. The disadvantage of the double-skinned multi-cabin structure is poor performance in weight and carrying efficiency: the weight gain of the double-skinned multi-cabin body structure is obvious, and it increases with the increase in the number of cabins. To solve the structural design problem of such civil aircraft with blended-wing-body, the disclosure provides a penetrating high wing structure of civil aircraft with blended-wing-body.

### SUMMARY

To solve the above problems, the purpose of the disclosure is to provide a penetrating high wing structure of civil aircraft with blended-wing-body. The floor slabs are spliced by guiding plates so that the adjustment can be made accurately during the assembly to ensure the levelness among multiple floors.

To achieve the above purpose, the disclosure provides the following technical solutions:

A penetrating high wing structure of civil aircraft with blended-wing-body, wherein the structure comprises a left wing, a right wing and a high wing penetrating central wing;

The left wing and the right wing are symmetrically arranged on two sides of the high wing penetrating central wing through fasteners respectively, and the high wing penetrating central wing is arranged on the top of the main body.

Preferably, the left wing and the right wing both comprise wing ribs and wing spars that are arranged in a crisscross way; the high wing penetrating central wing comprises a plurality of longitudinally arranged central wing frames and a plurality of central wing spars fixedly mounted in the central wing frames.

Preferably, the main body comprises a pressurized cabin and a cargo hold; the pressurized cabin is fixedly mounted at the bottom of the high wing penetrating central wing, and the cargo hold is fixedly mounted at the bottom of the pressurized cabin; two sides of the pressurized cabin are provided with a plurality of cabin doors.

Preferably, a plurality of partitions are arranged in the pressurized cabin in a crisscross way.

Preferably, the front end of the main body is connected to a nose through a first transition section.

Preferably, the rear end of the main body is connected to a rear body through a second transition section.

Preferably, an engine is provided in the upper center of the rear body, and the tail fins are provided on both sides of the rear body.

The disclosure has the following beneficial effects:

(1) The disclosure provides a penetrating high wing structure, wherein the wing and the body are designed as a whole so that the wings will not damage the continuity of the internal space of the body, which improves the load transfer efficiency of the structure and reduces the fasteners used for connection, thus reducing the weight of the body;

(2) According to the disclosure, the connection mode of the left wing-central wing-right wing is adopted, so that the connection mode of the wings on both sides is simplified and the carrying efficiency is improved;

(3) The penetrating high wing structure provided by the disclosure is an integral structure, and the wings can also be used for loading, with a high space utilization rate, which facilitates the arrangement of the propulsion unit, fuel tank and battery pack;

(4) The penetrating high wing structure in the disclosure has good aerodynamic characteristics, and the airflow can smoothly pass through the wing-body blending transition section, to achieve the purposes of reducing fuel consumption and developing green aviation;

(5) The disclosure facilitates the arrangement of the engine on the upper part of the rear body, which can effectively reduce the noise in the cabin and improve the comfort of the civil airliner;

(6) The penetrating high wing structure provided by the disclosure has a high lift-drag ratio and a high wing height above the ground, which facilitates cargo loading and unloading and personnel evacuation; the engine is high above the ground to prevent the ground debris from flying into the engine, thus causing damage;

(7) The penetrating medium and long wing structure in the disclosure is beneficial to carry both internal pressurization load and external bending moment load. The disclosure will be further described below with reference to the drawings and embodiments.

### BRIEF DESCRIPTION OF DRAWINGS

FIG. 1 is an overall structure diagram of a penetrating high wing structure of civil aircraft with blended-wing-body according to an embodiment of the disclosure;

FIG. 2 is a front view of a penetrating high wing structure of civil aircraft with blended-wing-body according to an embodiment of the disclosure.

In the figures: 1. Nose; 2. Central wing spar; 3. Central wing frame; 4. Right wing; 5. Second transition section; 6. Tail fin; 7. Engine; 8. Rear body; 9. Wing spar; 10. Wing rib; 11. Left wing; 12. Fastener; 13. High wing penetrating central wing; 14. First transition section; 15. Partition; 16. Cargo hold; 17. Pressurized cabin; 18. Cabin door.

### DETAILED DESCRIPTION OF THE PREFERRED EMBODIMENTS

The disclosure will now be described in detail with reference to the drawings and embodiments to more clearly clarify the purpose, technical solution and advantages of the disclosure. It should be understood that the preferred embodiments described herein are only to explain the disclosure and are not intended to limit the disclosure.

### Embodiment

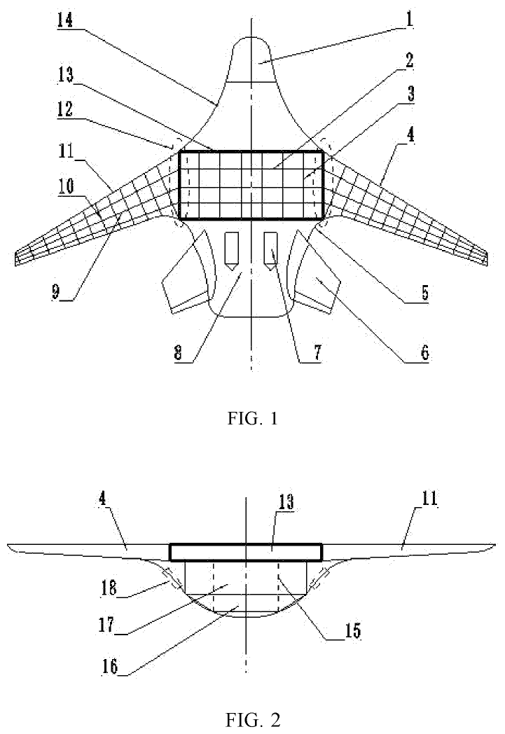

A penetrating high wing structure of civil aircraft with blended-wing-body, as shown in FIG. 1-2, wherein the structure comprises a left wing 11, a right wing 4 and a high wing penetrating central wing 13;

the left wing 11 and the right wing 4 are symmetrically arranged and connected to two sides of the high wing penetrating central wing 13 through fasteners 12 respectively, and the high wing penetrating central wing 13 is arranged on the top of the main body;

the left wing 11 and the right wing 4 both comprise wing ribs 10 and wing spars 9 that are arranged in a crisscross way; the wing ribs 10 and wing spars 9 near the outer side of the left wing 11 are sparsely arranged, and the wing ribs 10 and wing spars 9 near the inner side of the left wing 11 are densely arranged.

The high wing penetrating central wing 13 comprises a plurality of longitudinally arranged central wing frames 3 and a plurality of central wing spars 2 fixedly mounted in the central wing frames 3.

The left wing 11, the right wing 4 and the high wing penetrating central wing 13 are designed as a whole so that the wings will not damage the continuity of the internal space of the body, which shortens the force transmission path, improves the load transfer efficiency of the structure, and reduces the fasteners used for connection, thus reducing the weight of the body; moreover, the connection mode of the left wing-central wing-right wing is adopted, which simplifies the connection mode of the wings on both sides and improves the carrying efficiency compared with the connection mode of the left wing-body-central wing box-body-right wing;

the main body comprises a pressurized cabin 17 and a cargo hold 16; the pressurized cabin 17 is fixedly mounted at the bottom of the high wing penetrating central wing 13, and the cargo hold 16 is fixedly mounted at the bottom of the pressurized cabin 17; two sides of the pressurized cabin 17 are provided with a plurality of cabin doors 18 and emergency cabin doors; a plurality of partitions 15 are arranged in the pressurized cabin 17.

Specifically, the front end of the main body is connected to a nose 1 through a first transition section 14; the rear end of the main body is connected to a rear body 8 through a second transition section 5; an engine 7 is provided in the upper center of the rear body 8, which can reduce the noise in the cabin and improve the comfort of the civil airliner after the noise is shielded by the wings; the tail fins 6 are provided on both sides of the rear body 8.

The penetrating high wing structure provided by the disclosure is an integral structure with a high space utilization rate, which facilitates the arrangement and installation of the distributed propulsion system, the realization of distributed electric propulsion of the aircraft, and the arrangement of the integral fuel tank and battery pack; facilitates the shape and structure design of the transition section between the wings and the body to realize the efficient and smooth transition between the wings and the body and good aerodynamic characteristics, thus achieving the purposes of reducing fuel consumption and developing green aviation; facilitates the balance of bending moment, axial force, shear force and torque transmitted by the wings on both sides, and the load balance with the body structure; facilitates carrying and transmitting the pressurized load generated by the body and the bidirectional bending moment, torque and axial force of the body.

Moreover, the height of the wings above the ground is high, which shortens the height of the cabin/cargo hold above the ground and facilitates quick boarding and deplaning/loading and unloading, so the structure is suitable for large and medium-sized aircraft with blended-wing-body.

Although the disclosure has been illustrated and described herein with reference to preferred embodiments, it should not be construed as limiting the scope of the disclosure. Any modifications, equivalent substitutions and improvements that are within the spirit and principle of the disclosure are intended to be covered by the protection scope of the disclosure.

1. A penetrating high wing structure of civil aircraft with blended-wing-body, wherein the structure comprises a left wing (11), a right wing (4) and a high wing penetrating central wing (13);
the left wing (11) and the right wing (4) are symmetrically arranged on two sides of the high wing penetrating central wing (13) through fasteners (12) respectively, and the high wing penetrating central wing (13) is arranged on the top of the main body.

2. The penetrating high wing structure of civil aircraft with blended-wing-body according to claim 1, wherein the left wing (11) and the right wing (4) both comprise wing ribs (10) and wing spars (9) that are arranged in a crisscross way; the high wing penetrating central wing (13) comprises a plurality of longitudinally arranged central wing frames (3) and a plurality of central wing spars (2) fixedly mounted in the central wing frames (3).

3. The penetrating high wing structure of civil aircraft with blended-wing-body according to claim 1, wherein the main body comprises a pressurized cabin (17) and a cargo hold (16); the pressurized cabin (17) is fixedly mounted at the bottom of the high wing penetrating central wing (13), and the cargo hold (16) is fixedly mounted at the bottom of the pressurized cabin (17); two sides of the pressurized cabin (17) are provided with a plurality of cabin doors (18).

4. The penetrating high wing structure of civil aircraft with blended-wing-body according to claim 3, wherein a plurality of partitions (15) are arranged in the pressurized cabin (17) in a crisscross way.

5. The penetrating high wing structure of civil aircraft with blended-wing-body according to claim 3, wherein the front end of the main body is connected to a nose (1) through a first transition section (14).

6. The penetrating high wing structure of civil aircraft with blended-wing-body according to claim 3, wherein the rear end of the main body is connected to a rear body (8) through a second transition section (5).

7. The penetrating high wing structure of civil aircraft with blended-wing-body according to claim 6, wherein an engine (7) is provided in the upper center of the rear body (8), and the tail fins (6) are provided on both sides of the rear body (8).
